(19) United States
(12) Patent Application Publication
(10) Pub. No.: US 2011/0107246 A1
(43) Pub. Date: May 5, 2011

(54) UNDO/REDO OPERATIONS FOR MULTI-OBJECT DATA

(75) Inventor: Torbjorn VIK, Oslo (NO)

(73) Assignee: Schlumberger Technology Corporation, Sugar Land, TX (US)

(21) Appl. No.: 12/611,199

(22) Filed: Nov. 3, 2009

(51) Int. Cl. G06F 3/048

(52) U.S. Cl. 715/771

(57) ABSTRACT

Innovative undo/redo operations can be applied to separate objects or parts of objects within multi-object data, without having to undo and redo along a rigid chronological sequence of recorded operations. In one implementation, a user selects an object, or part of an object, and innovative undo/redo techniques enable the user to apply undo and redo operations to only the selected object or part, while skipping undo and redo operations for other objects. The undo/redo operations can also be applied in parallel to multiple objects. A graphical user interface (GUI) provides linear or hierarchical representations of operations applied to each object and displays undo/redo controls for each object.

### RELATED APPLICATIONS

This patent application is related to U.S. patent application Ser. No. ______ to Vik, Attorney Docket No. 94.0230, entitled, “Incremental Implementation Of Undo/Redo Support In Legacy Applications,” filed concurrently herewith, and incorporated herein by reference in its entirety.

### BACKGROUND

Interactive software applications operate on some type of data set. For example, the data set can be as simple as a text document; or can be a drawing, or a complex geophysical model. The end user creates, modifies and tunes this data set through a number of actions (“edit text”, “draw line”, “interpret horizon”) until a desired result is achieved. A useful tool for such applications is a technique known as “undo/redo”. This technique enables the end user to undo the most recent actions in order and as a result roll back the data set to the state in which it was before the action(s). Some applications, like document editing, can have multiple data sets (documents) active in parallel. These applications keep an individual action history for each open data set, and allow the end user to move backward and forward in the history independently for each active data set. There are many software applications that implement some form of undo/redo procedures, both single-step and multiple-step. But for a single given data set that contains multiple individual objects, there is no undo/redo procedure in which actions can be applied to either individual objects or to groups of objects and then undone/redone on a per-object basis.

### SUMMARY

Innovative undo/redo operations can be applied to separate objects or parts of objects within multi-object data, without having to undo and redo along a rigid chronological sequence of recorded operations. In one implementation, a user selects an object, or part of an object, and innovative undo/redo techniques enable the user to apply undo and redo operations to only the selected object or a part of the object, while skipping undo and redo operations for other objects. The undo/redo operations can also be applied in parallel to multiple objects instead of the conventional technique of undoing/redoing one operation at a time without regard for which objects were affected.

The innovative undo/redo operations can be integrated into many different new or legacy applications that create and edit multi-object data. For example, the undo/redo operations can be integrated into software programs that create word processor documents, spreadsheets, graphics files, CAD models, and other data sets.

In one implementation, an example method determines select objects or features distinguishable in a given data set. Each edit on the data set is stored in a stack or other record. The identities of objects affected by an edit are then associated with the record of the edit stored in the stack. The stack can be filtered to provide undo and redo operations limited to the editing history of a given object or part of an object without modifying the other objects. In another implementation, a data structure representing different objects in a data set is created first, and then a record of each edit is associated with a corresponding identity of an object or part of an object in the data structure, and stored for future undo/redo operations in the context of that object. A graphical user interface (GUI) can provide linear and visual tree representations of dynamically updated undo and redo options for all select objects in a data set.

This summary section is not intended to give a full description of innovative undo/redo operations for multi-object data, or to provide a comprehensive list of features and elements. A detailed description of example implementations of the undo/redo operations for multi-object data follows.

### BRIEF DESCRIPTION OF THE DRAWINGS

FIG. 1 is a diagram of an example editing flow for undo/redo operations.

FIG. 2 is a diagram of an innovative undo/redo system.

FIG. 3 is a block diagram of an example undo-redo engine introduced in FIG. 2, in greater detail.

FIG. 4 is a block diagram of engine components that construct a data structure for performing per-object undo/redo.

FIG. 5 is a diagram of an example data structure introduced in FIGS. 3 and 4, in greater detail.

FIG. 6 is a diagram of a chronological stack associated with an individual object.

FIG. 7 is a diagram of another example of the data structure of FIG. 3, in greater detail.

FIG. 8 is a diagram of a first example graphical user interface (GUI) state.

FIG. 9 is a diagram of a second example GUI state.

FIG. 10 is a diagram of a third example GUI state.

FIG. 11 is a diagram of a fourth example GUI state.

FIG. 12 is a diagram of the GUI of FIG. 8 in the context of a corresponding visual model.

FIG. 13 is a diagram of an example GUI in which undo/redo controls for each object are placed in a fixed position.

FIG. 14 is a flow diagram of an example method of performing a per-object undo/redo operation.

FIG. 15 is a flow diagram of an example method of creating a graphical user interface (GUI) for per-object undo/redo operations.

### DETAILED DESCRIPTION

### Overview

This disclosure describes innovative undo/redo operations that improve upon conventional undo and redo techniques that are constrained to the rigid sequence of a single chronological history of operations performed globally across an entire data set. In conventional undo scenarios, the user must accept an undo sequence that backtracks edits in a reverse order of the literal chronological order in which the original edits occurred anywhere in the data set. Likewise, conventional redo operations re-execute the same unchangeable sequence of operations that were undone. Thus, conventional undo/redo techniques require the user to accept unwanted operations with the desirable ones.

The innovative undo/redo operations described herein can be applied to separate objects, or even parts of objects, within a data set, without having to undo and redo within a rigid chronological sequence of recorded operations. As used herein, the term “object” means an object or a part of an object. That is, a user or an innovative process may select or partition an object into parts or features, in which case each part or feature can be treated as an object in its own right. Thus, “object” as used herein means a logical subset or a selected subset of data within a larger data set, designated as a nexus for undo/redo operations associated with that subset. “Features” and “objects” will be referred to herein as “objects.” In one implementation, an object is a visual or a logical partition of an application's data set by which a global history of edits can be filtered to provide “per-object” or “across-selected-multiple-objects” undo and redo operations, without having to undo and redo previous edits in strict backward and forward chronological order.

Thus, in one implementation, a user selects an object, or part of an object, and innovative undo/redo techniques enable the user to apply undo and redo operations to just that object or part of an object, while skipping undo and redo operations for other objects. A user may also apply undo/redo operations in parallel across multiple objects, rather than following a single linear path of undo/redo operations.

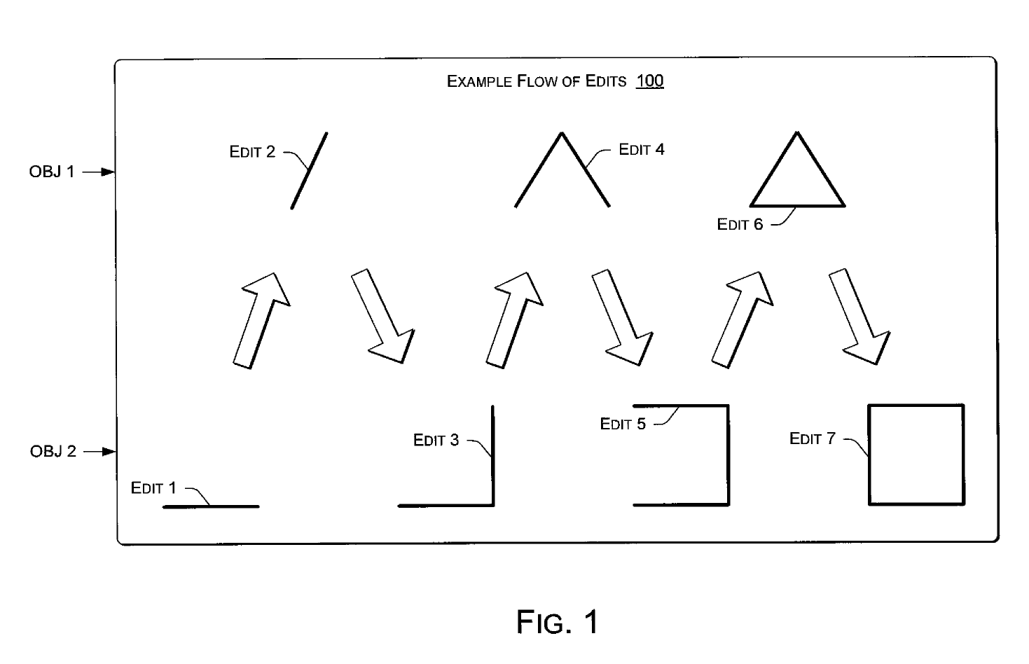

FIG. 1 shows an example flow of edits 100 to introduce the principle of “per-object” undo/redo operations. In this example, the user has alternated each editing operation between two different objects: construction of a square and construction of a triangle. The flow of original editing follows the white arrows in FIG. 1. In a conventional scenario, to undo the construction of two sides of the finished square, i.e., to backtrack from edit 7 to edit 3 in FIG. 1, the user must proceed in reverse order of the white arrows without deviation. During the conventional undo sequence, the bottom of the finished triangle is undesirably removed when edit 4 in FIG. 1 is reversed: an unwanted result.

In the innovative undo/redo operations described herein, the two processes of undoing and redoing can distinguish between separate objects or parts of objects within multi-object data. Thus, in FIG. 1, the user can choose to undo only the edits for the square object, i.e., undoing the sequence of edits that includes only edits 7, 5, 3, 1 in FIG. 1; or can choose to undo only the edits for the triangle object, i.e., undoing the sequence of edits that includes only edits 6, 4, 2. Such a “per-object” undo operation has a counterpart redo operation that follows a forward order of the same sequence of edits that is limited to the selected individual object.

As introduced above, the innovative undo/redo operations can be integrated into various new and legacy software applications that create and edit sets of data. Example data sets include word processor documents, spreadsheets, graphics files, CAD models, etc. In one implementation, an example method determines objects or features distinguishable in a given data set. Such object recognition may be achieved by applying an algorithm that recognizes data patterns or similarities; by manual user-selection of objects; or by preprogramming different objects into the data set that a given software application will create and modify.

In one implementation, each edit on a data set is stored in a stack. An associative mechanism links objects affected by an edit with the record of the edit in the stack. The stack can then be filtered to provide undo and redo operations limited to the editing history of a given object without changing past edits of the other objects. In another implementation, identities of objects are structured in a database, and a record of each edit is associated with the identity of each object it affects, so that there is no construction of a single, global, chronological stack.

An associated graphical user interface (GUI) can provide linear or branched visual representations of possible “per-object” or “across objects” undo/redo operations. The GUI can provide a visual tree format that shows editing histories per-object, with dynamically placed undo and redo controls for each object in a data set. In one variation, undo and redo controls relocate on the GUI so that the controls are always at displayed operations for a given object or group of objects that can currently be undone or redone. Alternatively, the undo/redo controls can be fixed in one location per-object on the GUI, instead of relocating near each current operation that can be undone or redone.

The innovative undo-redo operations can be integrated into new programming code or in some instances installed as a retrofit to incrementally upgrade some types of editing operations in pre-existing software applications that use conventional undo/redo operations.

Example Environment

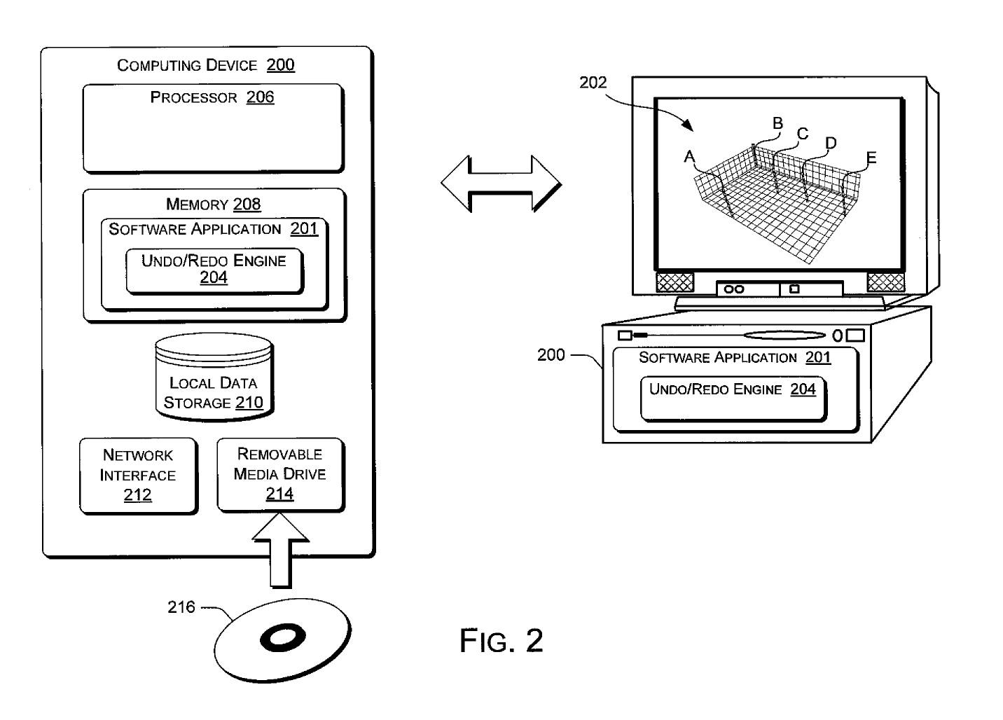

Examples of the undo/redo operations described herein can be practiced within various software applications, as used in a computing environment. FIG. 2 shows an example computing environment, including computing device 200 running a software application 201, in this case a modeling application that generates a visual model 202. The software application 201 includes an innovative undo/redo engine 204 integrated into its programming code. The computing device 200, hosting both the software application 201 and the undo/redo engine 204, also includes typical hardware, such as a processor 206, memory 208, local data storage 210, a network interface 212, and a removable media drive 214—such as an optical disk read/write device for receiving a removable storage medium 216. The removable storage medium 216 can be, for example, a compact disk (CD) or digital versatile disk/digital video disk (DVD) that may include instructions for implementing and executing the undo/redo engine 204. In a manner similar to the modeling application, which can exist at least in part as software instructions in the memory 208, at least some parts of the innovative undo/redo engine 204 can be stored as instructions on a given instance of the removable storage medium 216 or in local data storage 210, to be loaded into memory 208 for execution by the processor 206. The undo/redo engine 204 may also be implemented as electronic hardware, such as one or more application specific integrated circuits (ASIC chips); or combinations of hardware and software, e.g., instructions from a removable storage medium 216 running on the hardware.

The example modeling application generates a data set, which in the example of FIG. 2 includes at least five objects A, B, C, D, and E with their respective parameters. In this example, the visual model 202 depicts reservoir geophysics, and the objects A, B, C, D, and E are wells. Each of the five objects (wells) can be edited separately, and in any order. For example, each well can be user-defined by assigning a location and depth; and then named, color-coded, and so forth. If the user has made edits to the wells in a random manner, jumping from well to well in the editing process, then, in one scenario, the innovative undo/redo engine 204 enables the user to undo and redo the edit history as limited to just one of the wells, without affecting the edits associated with the other wells. In another scenario, the undo/redo engine 204 enables the user to perform undo/redo operations globally across multiple selected objects at once. Thus, in this example, if a similar action has recently been applied to wells A, B, and C, then an undo operation can be applied to all three wells in one simultaneous or sequential operation.

Example Undo/Redo Engine

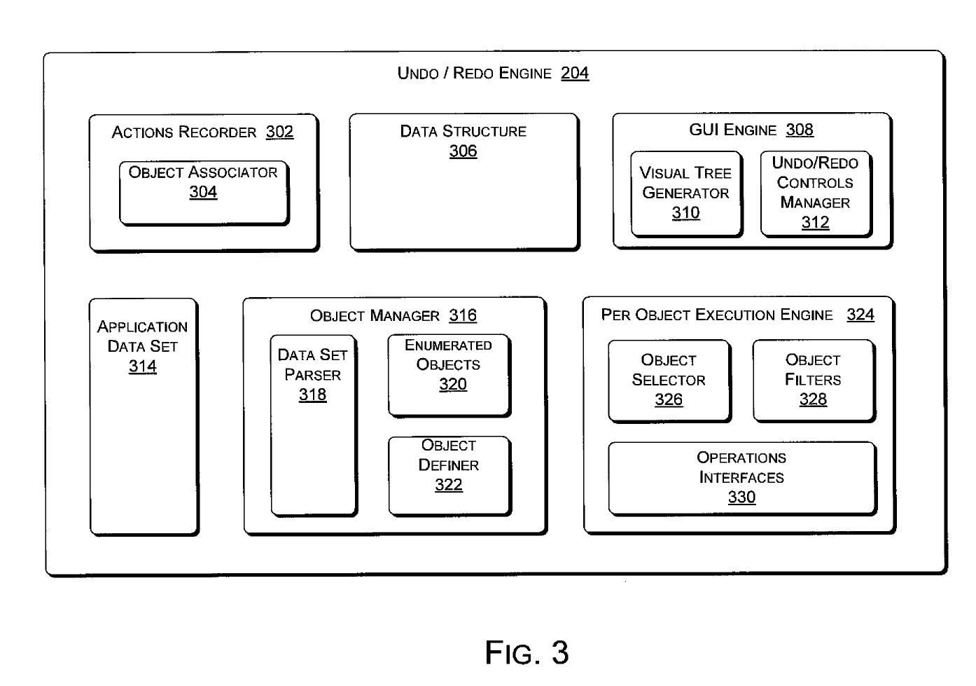

FIG. 3 shows the example undo-redo engine 204 of FIG. 2, in greater detail. The illustrated implementation is only one example configuration, to introduce some features and components of an engine that performs the innovative undo/redo techniques. Many other arrangements of the components of an innovative undo-redo engine are possible within the scope of the subject matter. As introduced above, the undo-redo engine 204 can be implemented in hardware, or in combinations of hardware and software. Illustrated components are in communication with each other as needed.

Providing now a list of components, the illustrated undo-redo engine 204 includes, from top left to bottom right, an actions recorder 302 and object associator 304, which generate a data structure 306 for storing a record, or history, of each edit operation performed; a graphical user interface (GUI) engine 308 including at least a visual tree generator 310 and an undo/redo controls manager 312; a buffer or access interface in the undo/redo engine 204 for storing or accessing the application data set 314; an object manager 316 that includes a data set parser 318 for determining enumerated objects 320 and/or an object definer 322 for determining the enumerated objects 320; and a per-object execution engine 324, which includes an object selector 326, object filters 328, and operations interfaces 330.

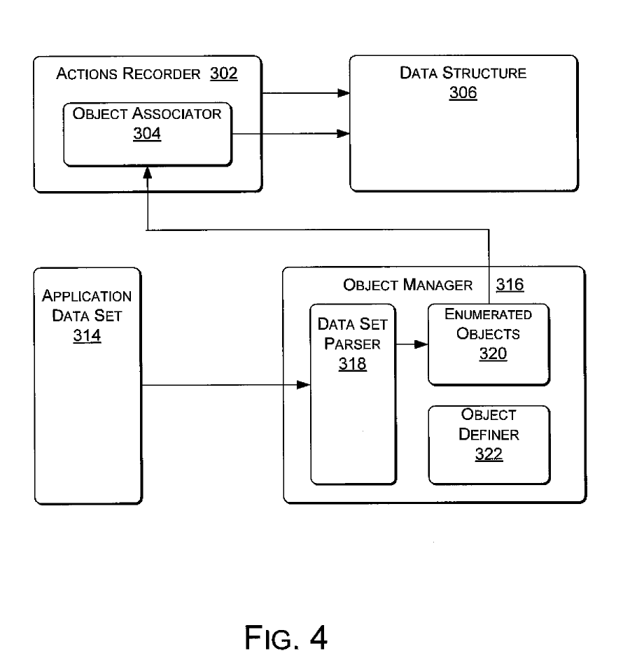

As shown in FIG. 4, the application data set 314 is the overall data created and maintained by a particular application, for example, a document file for a word processor application. Arrows in FIG. 4 represent component (data) inputs and outputs. The actions recorder 302 commits each user-initiated edit or operation to a record, arranged as the data structure 306. The recording of the data structure 306 may occur in permanent storage, e.g., on local data storage 210 or in volatile memory, such as a random access memory 208. The data structure 306 may be a chronological stack of actions performed or may be a structure of enumerated objects. When the data structure 306 is a chronological stack, the object associator 304 in the actions recorder 302 links the identity of one or more objects affected (i.e., modified) by a given action to the record for that action in the chronologically stacked data structure 306. Alternatively, when the data structure 306 is a hierarchy or other arrangement of enumerated objects 320, the object associator 304 may link the record of each user-initiated action to the identity of the affected object or objects arranged in the data structure 306. The data structure 306 does not have to be sequenced in a chronological order. However, constructing the data structure 306 in a chronological order as edits occur automatically stores useful temporal information in the data structure 306 without having to store an extra timestamp field in the record when an alternative non-chronological structure scheme is used.

Returning to FIG. 3, the object manager 316 creates and provides the list of enumerated objects 320, for example, to the object associator 304 for creating the data structure 306; to the GUI engine 308 for creating a visual tree branched according to objects; and to the per-object execution engine 324 for performing undo/redo operations by object. The data set parser 318 can apply a recognition scheme or algorithm to the application data set 314 to discern individual objects represented in the data set 314. Alternatively or in addition, an object definer 322 can enable the user to manually designate objects or parts of objects to which specified undo/redo operations will apply. As previously mentioned, objects can also be preprogrammed into the fabric of a given application and its corresponding data set 314.

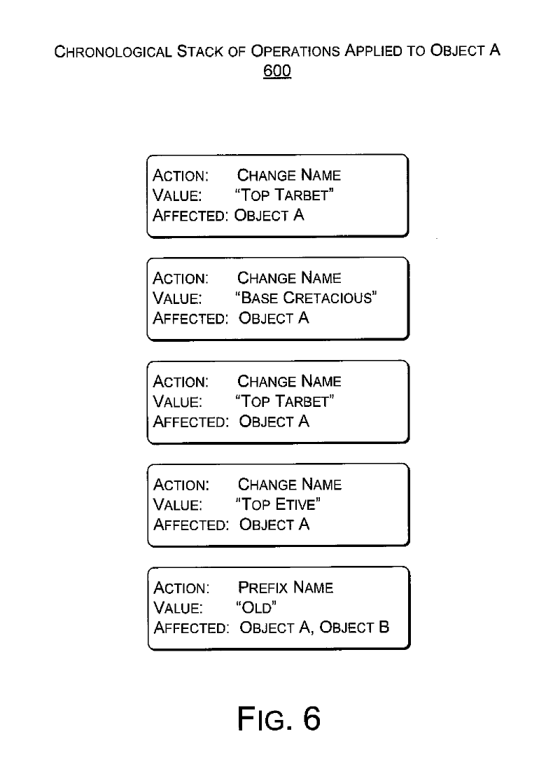

The per-object execution engine 324 performs the undo and redo operations specific to a given individual object, object part, or group of selected objects. The object selector 326 specifies the designated object, part of an object, or group of objects for a given undo/redo operation. The object selector 326 typically designates the object upon which an undo/redo operation will be performed, from user input received via controls displayed by the GUI engine 308. The execution engine 324 may have a set of object filters 328 with which to generate a filtered sequence of past edits specific to the individual object—or group of objects—designated for undo or redo. In one implementation, one or more object filters 328 point to relevant parts of the data structure 306 in which a history of actions applied to a selected object or objects reside, instead of sorting or filtering a linear chronological stack by one or more object identities. In one implementation, the execution engine 324 applies a given object filter 328 to a chronologically stacked version of the data structure 306 in order to derive a filtered sequence of operations specific to a corresponding individual object (described further below with respect to FIG. 6).

The per-object execution engine 324 includes operations interfaces 330 to communicate with the given application in order to control particular types of editing operations to which the per-object undo/redo operations apply. The execution engine 324 may use conventional undo/redo techniques, but apply these to a sequence of only those operations that have been performed on an individual object.

The undo/redo engine 204 also includes a GUI engine 308 to control a graphical user interface that shows the user a representation of different objects available for undo/redo operations. The undo/redo controls manager 312 displays undo/redo controls for selecting the undo/redo operations available for each object represented on the GUI. The GUI engine 308 can display linear sequences of per-object operations, or the visual tree generator 310 can also use the enumerated objects 320 or the data structure 306 to generate a visual tree that shows objects available for undo/redo operations. The visual tree may be structured to show undo/redo operations available to be applied to multiple objects, either simultaneously or in a sequence that excludes action on other unselected objects. The undo/redo controls manager 312 can dynamically arrange undo/redo controls at current and logically available undo/redo operations listed for each object on the GUI, to provide very specific information about which action is to be undone or redone next. Or, in a variation, the undo/redo controls manager 312 can place fixed-position undo/redo controls, e.g., at the top of each column representing a list of actions associated with a given object. The fixed-position controls undo or redo a relevant action associated with the object under the column, without the user having to chase moving controls on the GUI.

Example Operation of an Undo/Redo System

The innovative undo/redo engine 204 can be used in software applications that operate on a data set 314 consisting of a potentially large number of individual objects, which may be modified independently or in groups by the innovative undo/redo operations. An example application is reservoir modeling, with a data set 314 containing a number of geological horizon interpretations. To modify these horizons, the user can select from a number of interactive actions, such as “shift horizon by given distance” or “shift all horizons by given distance”. With conventional undo/redo techniques, all user actions are stored in a linear, chronological stack of actions. Thus, even if actions applied to horizon A and horizon B are completely independent (no group-actions), the user still has to move backwards in strictly reverse chronological order. The undo/redo engine 204, however, enables the user to move backwards through the A-actions and B-actions independently, improving user productivity. The data structure 306 described herein supports this feature of per-object undo/redo operations while correctly handling group-actions and ensuring data integrity.

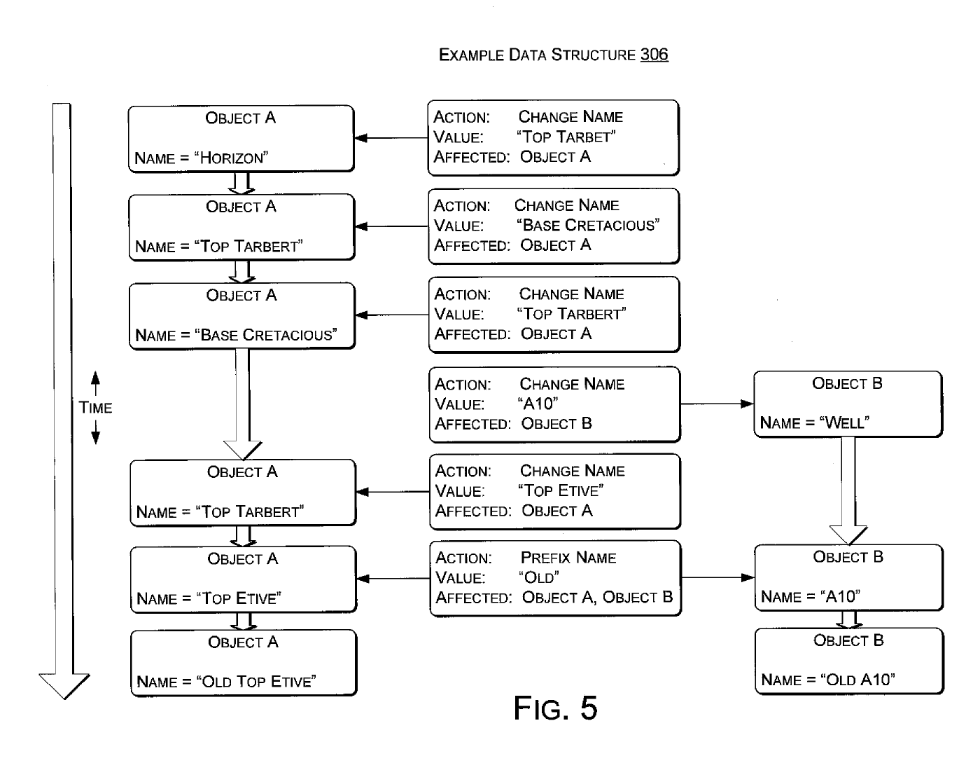

FIG. 5 shows an example data structure 306, in greater detail. The data structure 306 shows part of the editing lifetimes of two objects (A and B) in a given data set 314. A number of actions are applied to them (center stack) and the data structure 306 keeps track of which objects were modified.

The execution engine 324 can then apply an object filter 328 to find all actions in the data structure 306 that were applied, for example, to Object A. In one implementation, this filtering produces a second chronological stack of operations belonging to Object A, as shown in FIG. 6. The per-object execution engine 324 can now move backward in the history of Object A without having to undo the single action that was only applied to Object B.

Example Graphical User Interfaces (GUIs)

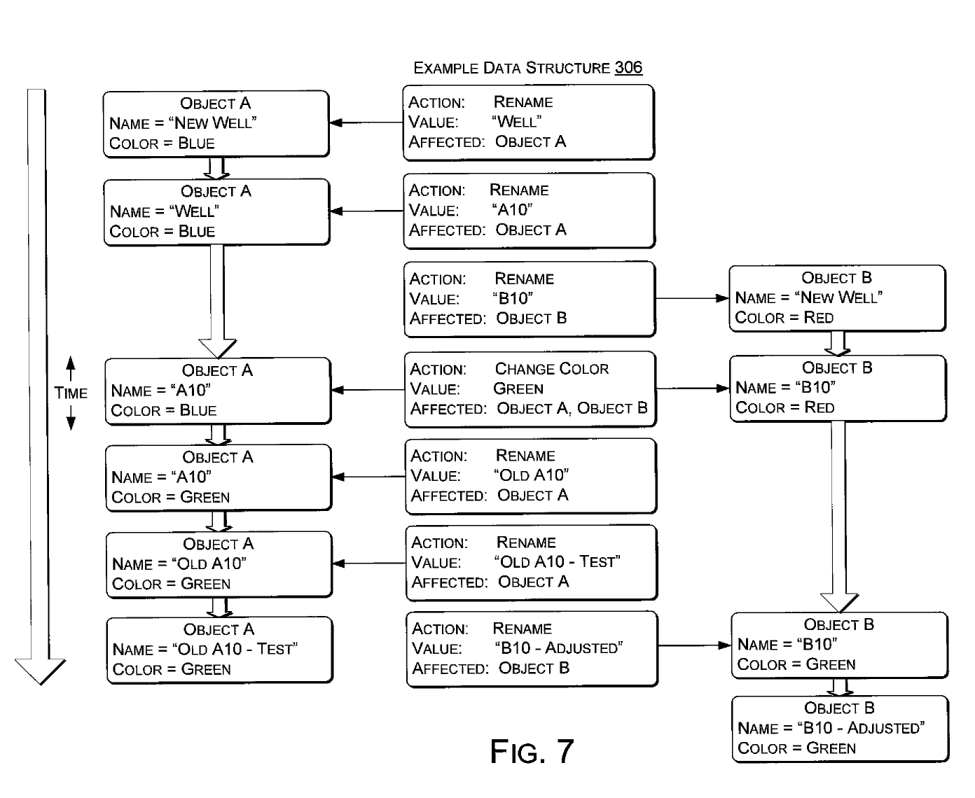

FIG. 7 shows another data structure 306 similar to that of FIG. 5. Presenting such a data structure 306 to the end user in a useful manner enables the user to easily apply the innovative undo/redo operations to the edits of a particular object.

The data structure of FIG. 7 shows an example action history resulting from a sequence of interactive actions (center stack). The leftmost and rightmost vertical columns describe the lifetime of two objects (A and B), which in this example are wells in a reservoir model, such as a model producing the visual model 202 of FIG. 2. At one point in the sequence (the center stack) a “change color” editing operation is applied to both Objects A and B, which illustrates some GUI characteristics.

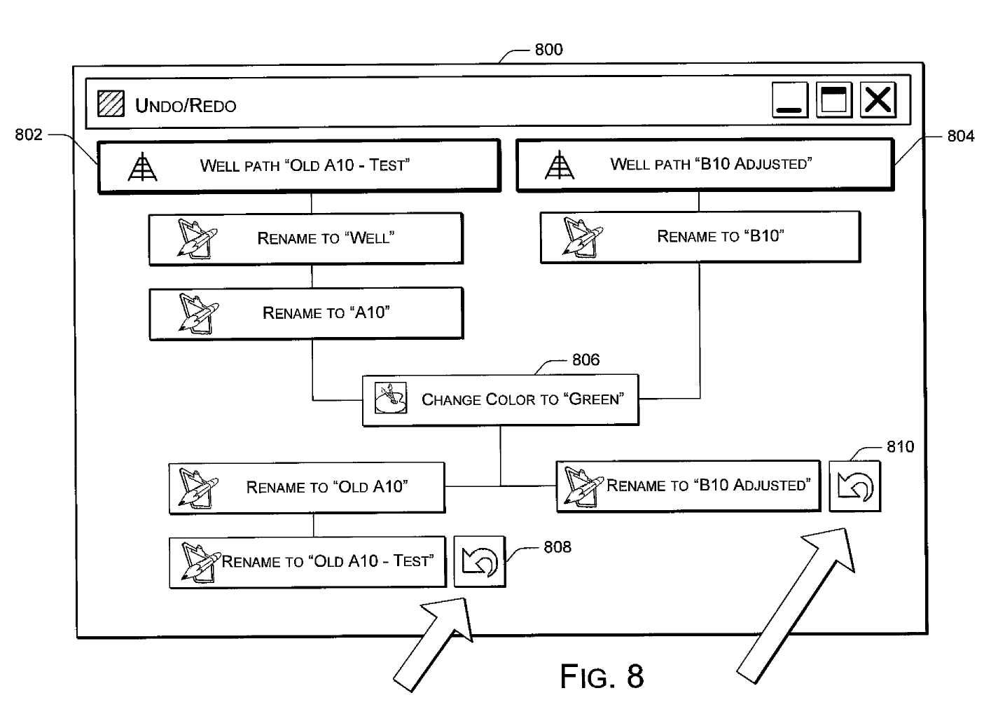

FIGS. 8-12 show a sequence of GUI states in which the undo/redo controls manager 312 dynamically locates control buttons next to relevant actions that are displayed. FIG. 8 shows an example GUI 800. GUI 800 shows a visual tree for two objects represented in a data set 314: an object called “Well path Old A10—Test” and an object called “Well path B10 Adjusted.” In one implementation, the GUI engine 308 displays all actions that have been applied to a given object in a vertical column below title boxes 802, 804 for each specific object. In this example, the visual tree generator 310 produces a visual structure, connected by black lines. Any action applied to multiple objects, such as a global “change color” action 806 is displayed as a joinder of the lines for all affected objects. FIG. 8 shows an example GUI 800 that includes two objects, but the same GUI techniques can be applied to any number of objects. The example GUI 800 displays information from a given data set 314 that contains multiple individual objects so that actions can be applied to either individual objects or groups of objects.

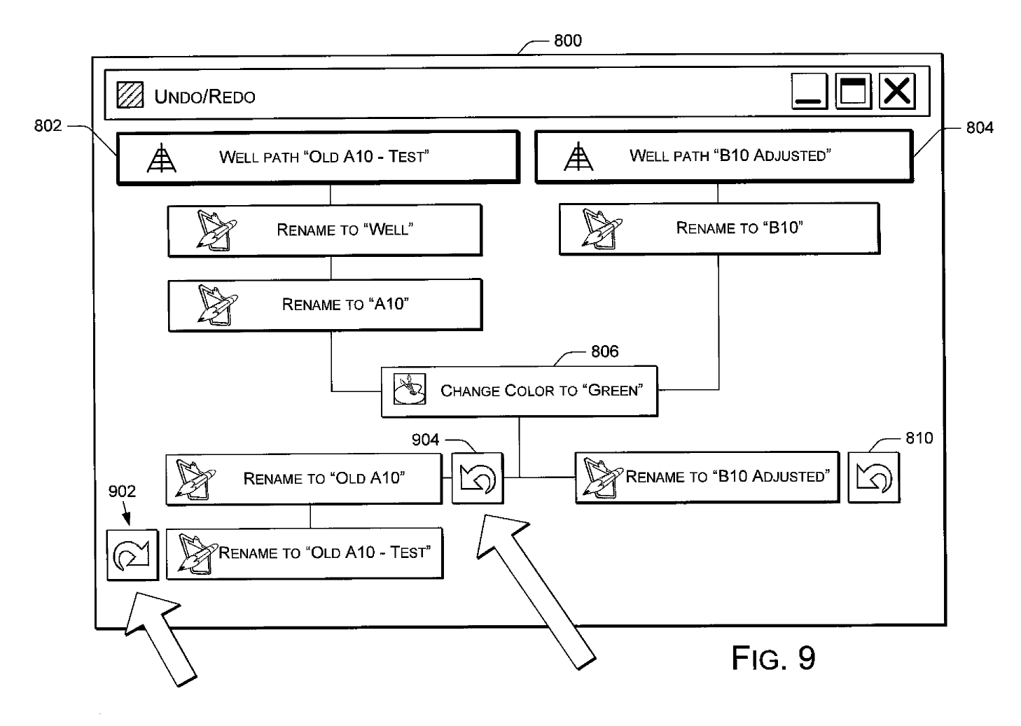

Next to the two bottom actions in FIG. 8 there are two buttons indicated by white arrows displaying standard “Undo” icons 808, 810. Clicking the Undo icon 808 undoes the adjacent action and, in this case, produces the GUI state shown in FIG. 9.

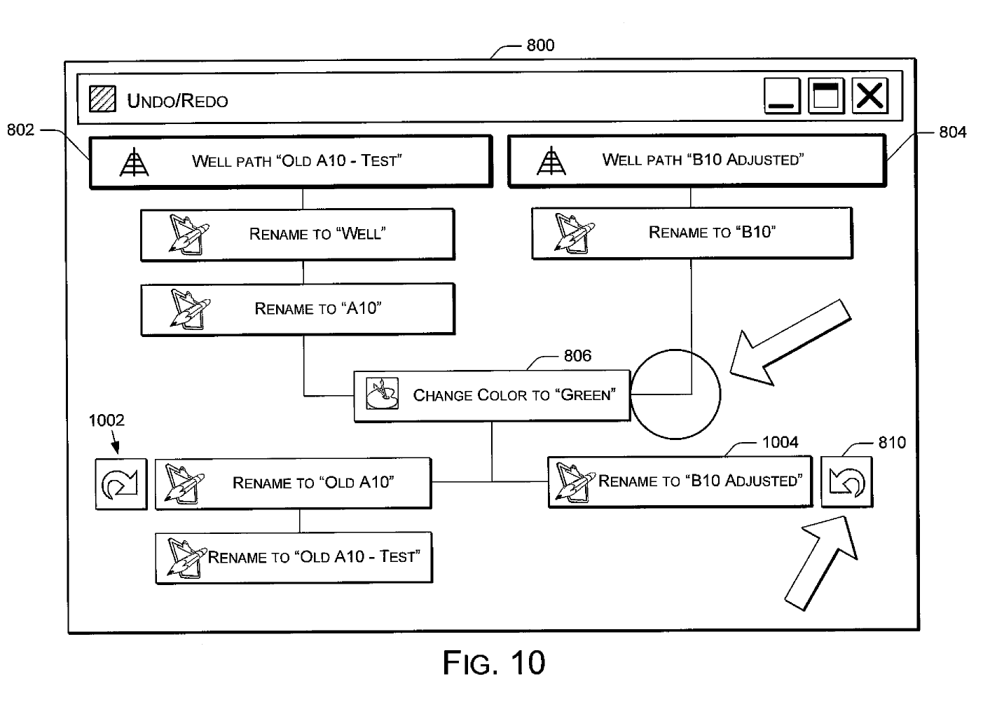

With regard to FIG. 9, the undo/redo controls manager 312 displays a Redo icon 902 in the lower left corner (left white arrow). The undo/redo controls manager 312 moves the Undo icon 808 in FIG. 8 up to become Undo icon 904 (right white arrow) designating the next action that can be undone in the history of operations for that object. Clicking the Undo icon 904, yields the GUI state shown in FIG. 10.

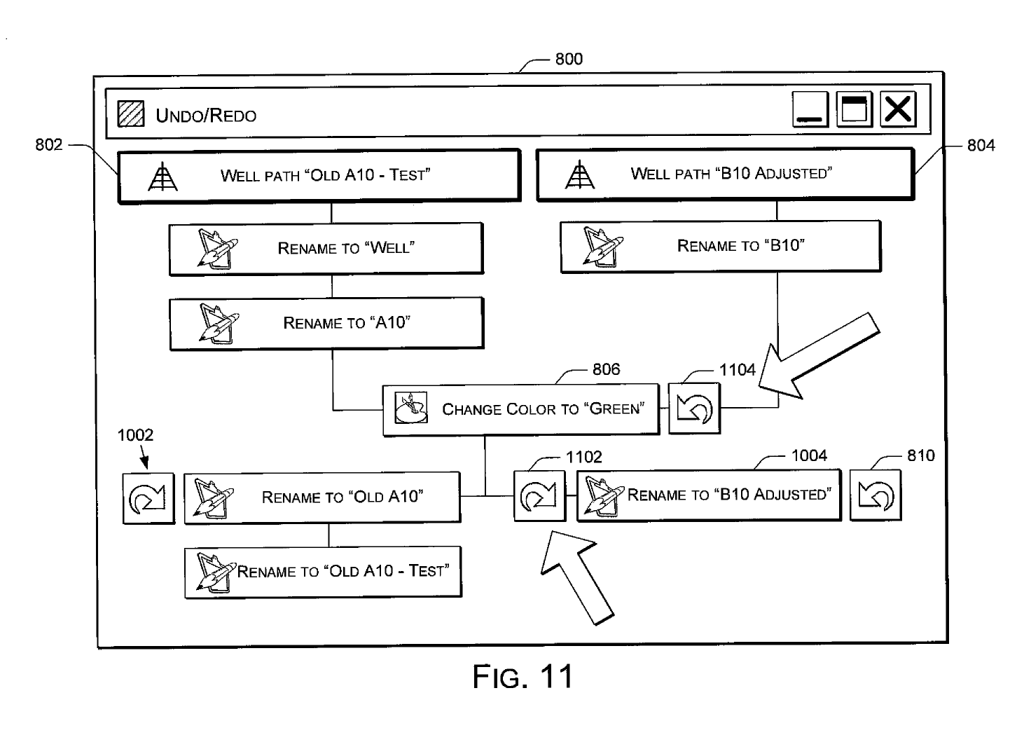

In FIG. 10, the undo/redo controls manager 312 has moved the Redo icon 902 of FIG. 9 up one operation to become Redo icon 1002 in FIG. 10 (because of the Undo operation just executed with respect to FIG. 9). The undo/redo controls manager 312 omits posting an Undo icon button next to the “change color” operation 806 (upper white arrow). This is because, in one implementation, actions must be undone in reverse chronological order per-object (or per part of an object), and as the “change color” operation 806 was applied to both objects, the operation 806 cannot be undone before the “Rename to ‘B10—Adjusted’” operation 1004 is also undone. Actuating the Undo icon 810 in FIG. 10 (lower white arrow) yields the GUI state shown in FIG. 11.

In FIG. 11, because actuating the Undo icon 810 has rolled back the undoing of operations for the object 804 on the right, a new Redo icon 1102 (lower white arrow) appears next to the operation just undone, and the undo/redo controls manager 312 now displays an Undo icon 1104 (upper white arrow), next to the group, which can now be undone for both of the objects displayed in the GUI 800. The same joint effect also applies when redoing actions: for a group action affecting objects A and B, all actions applied to objects A and B prior to the group action must be redone before operation A is eligible to be redone. Logic built into the undo/redo controls manager 312 keeps track of which Undo and Redo buttons are shown in the GUI 800, and their logical arrangement among the displayed operations.

FIGS. 8-11 thus show relationships between a given operation and the objects it affects, and allows the end user to move through separate undo/redo stacks for each object, performing actions on a per-object or per part basis, as opposed to conventional techniques that backtrack through a single, strictly chronological action history for an entire data set.

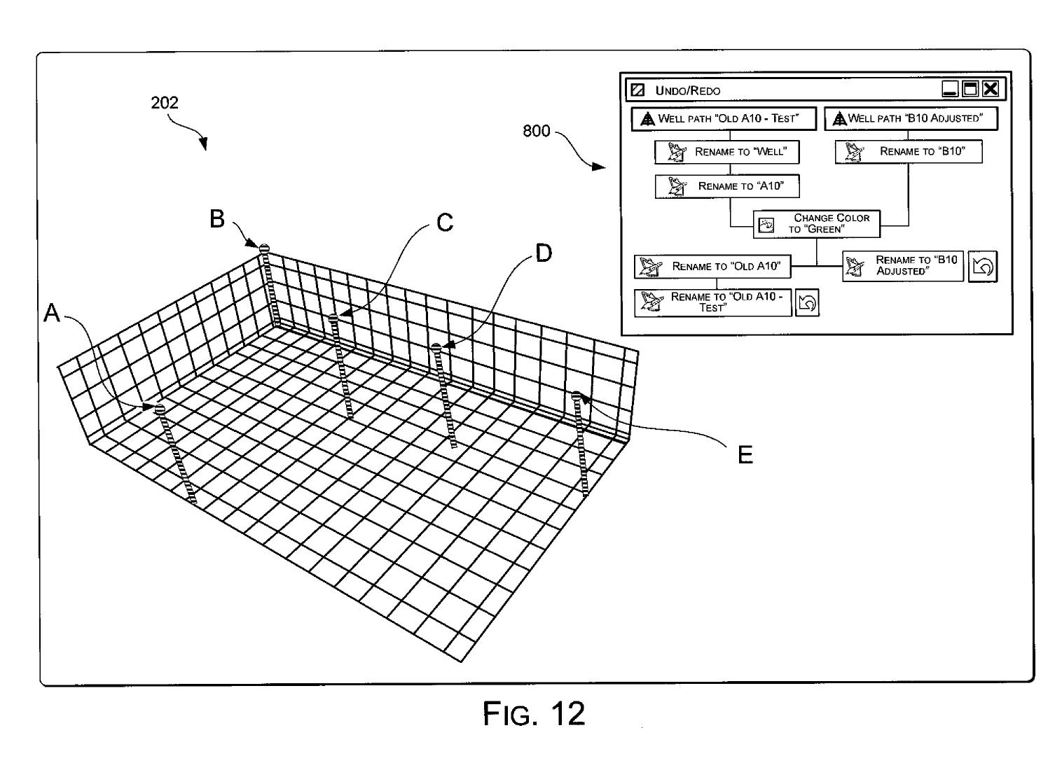

FIG. 12 shows the GUI 800 of FIG. 8 in the context of the corresponding visual model 202 introduced in FIG. 2. The GUI 800 shows a visual tree of operations that can be undone/redone for Object A and Object B, which appear in the visual model 202. Thus, FIG. 12 depicts an example graphical output that the innovative system shown in FIG. 2 can produce for presentation on a display monitor.

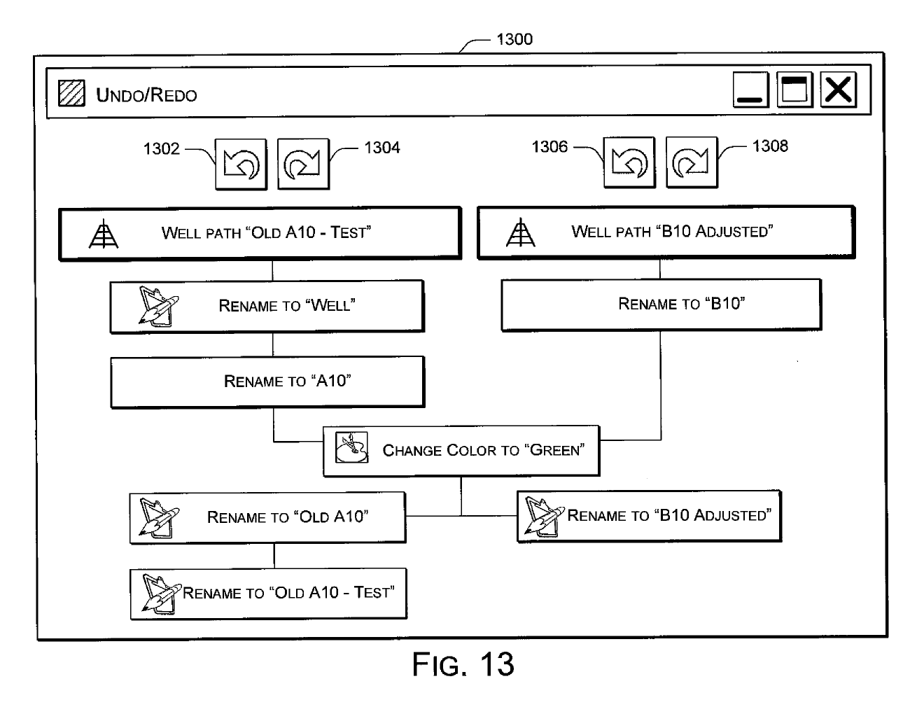

FIG. 13 shows an example GUI 1300 in which undo/redo controls for each object are placed in a fixed position. In GUI 1300, undo/redo controls 1302 and 1304 for Object A, represented by the column of operations on the left, are positioned above the column. Likewise, undo/redo controls 1306 and 1308 for Object B, represented by the column of operations on the right, are positioned above the column. The fixed control buttons enable a user to undo and redo without having to constantly reposition a cursor to track moving control buttons. When an undo or redo operation for an object becomes unavailable, the relevant control button at the top of the column may disappear or visually fade to indicate an inoperative state of the control button. Actuation of a redo or undo button in a fixed location on the GUI automatically performs the next undo or redo operation in the queue for the associated object.

Example Methods

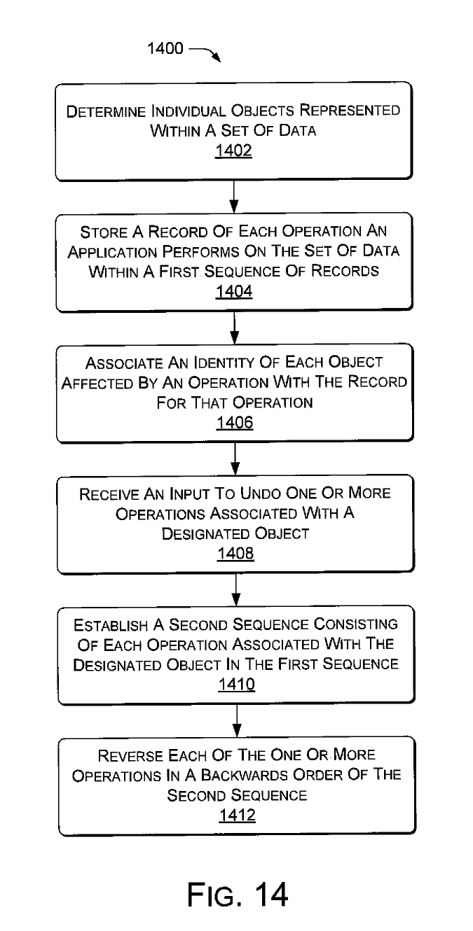

FIG. 14 shows an example method 1400 of performing a per-object undo/redo operation. In the flow diagram, the operations are summarized in individual blocks. The example method 1400 may be performed by hardware or combinations of hardware and software, for example, by the example undo/redo engine 204.

At block 1402, individual objects represented within a set of data are determined.

At block 1404, a record of each operation an application performs on the set of data is stored within a first sequence of records.

At block 1406, an identity of each individual object affected by an operation is associated with the record of the operation stored in the first sequence.

At block 1408, an input to undo one or more operations associated with a designated individual object is received.

At block 1410, a second sequence consisting of each operation associated with the designated individual object in the first sequence is established.

At block 1412, based on the input to undo one or more operations, each of the one or more operations associated with the designated individual object is reversed in a backward order of the second sequence.

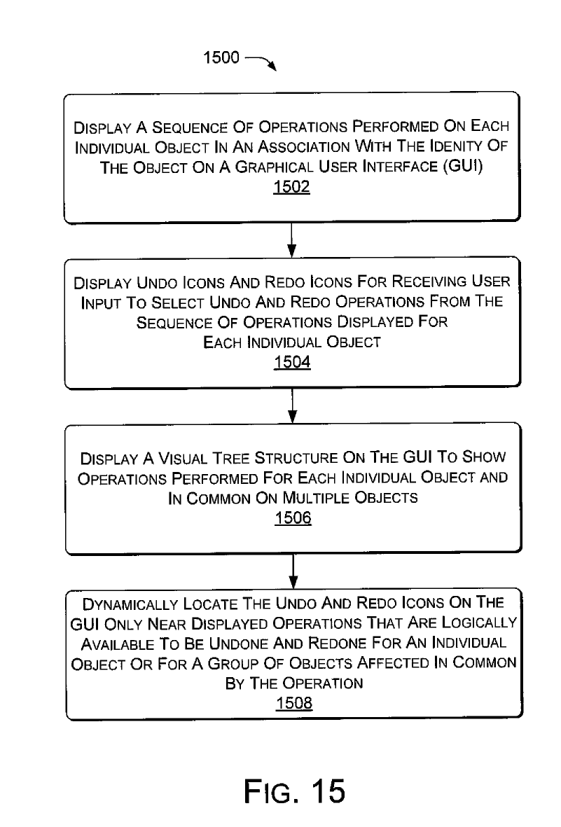

FIG. 15 shows an example method 1500 of creating a graphical user interface (GUI) for per-object undo/redo operations. In the flow diagram, the operations are summarized in individual blocks. The example method 1500 may be performed by hardware or combinations of hardware and software, for example, by the example undo/redo engine 204.

At block 1502, a sequence of operations performed on each individual object is displayed in association with the identity of the object on the GUI.

At block 1504, undo icons and redo icons are displayed for receiving user input to select undo and redo operations from the sequence of operations displayed for each individual object.

At block 1506, a visual tree structure is displayed on the GUI to show operations performed on each individual object and on multiple individual objects.

At block 1508, the undo icons and redo icons are dynamically placed on the GUI only near displayed operations that are logically available to be undone and redone for an individual object or for a group of objects affected in common by the operation.

### CONCLUSION

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

1. A computer-executable method (1400), comprising:
determining individual objects represented within a set of data; (1402)
storing a record of each operation an application performs on the set of data; (1404)
associating the record of each operation with an identity of each individual object affected by the operation; (1406)
receiving an input to undo one or more operations associated with an individual object; (1408) and
based on the input to undo, reversing only the one or more operations associated with the individual object. (1412)

2. The computer-executable method as recited in claim 1, further comprising:
receiving an input to redo one or more of the reversed operations associated with the individual object; and
redoing the one or more reversed operations associated with the individual object in a forward order of the reversed operations.

3. The computer-executable method as recited in claim 1, wherein the set of data comprises one of word processor data, text data, spreadsheet data, visual data, visual drawing data, graphics data, webpage data, computer assisted drawing (CAD) data, photography data, imaging data, audio data, editing data, modeling data, earth science modeling data, geography modeling data, mining data, physics data, chemistry data, biology data, electronics data, applied mathematics data, medical data, financial data, or mapping data.

4. The computer-executable method as recited in claim 1, wherein said storing a record of each operation an application performs on the set of data includes storing a record of each operation in real time or in near real time in a chronological order.

5. The computer-executable method as recited in claim 1, wherein said determining individual objects represented within a set of data comprises one of receiving a user input selecting the individual objects represented within the set of data, receiving a user input selecting parts of objects within the set of data, preprogramming the individual objects to be generated within the set of data, grouping data according to a common similarity to define each individual object, or applying a clustering algorithm to distinguish each individual object from other objects in the set of data.

6. The computer-executable method as recited in claim 1, further comprising filtering the records of the operations for records associated with an individual object.

7. The computer-executable method as recited in claim 1, wherein reversing an operation based on the input to undo includes reversing the operation for multiple individual objects associated with the operation; and
wherein redoing an operation based on an input to redo includes redoing the operation for multiple individual objects associated with the operation.

8. The computer-executable method as recited in claim 1,
wherein said storing a record of each operation an application performs on the set of data stores the data as a first sequence of records;
further comprising establishing a second sequence consisting of each operation associated with the individual object in the first sequence; and
based on the input to undo, reversing each of the one or more operations associated with the individual object in a backwards order of the second sequence.

9. The computer-executable method as recited in claim 1, further comprising extending a graphical user interface (GUI), including:
for each of multiple individual objects, displaying a sequence of operations performed on each individual object; and
displaying an interface for receiving a user input to select undo and redo operations from the sequence of operations displayed for the individual object.

10. The computer-executable method as recited in claim 9, further comprising displaying a tree structure in the GUI;
wherein the tree structure shows the sequence of operations performed on each individual object; and
wherein the tree structure also shows operations performed in common on multiple individual objects.

11. The computer executable method as recited in claim 10, further comprising dynamically relocating undo and redo control icons on the GUI to indicate which operations performed on an individual object are eligible for an undo/redo operation.

12. The computer executable method as recited in claim 10, further comprising fixing undo and redo control icons in a static location related to a branch of the tree structure representing an individual object to which the undo and redo control icons apply.

13. A computer-readable medium (216), including instructions, which when executed, cause a computer to:
receive an input (332) via an application for initiating an operation to modify a data set (306);
create a data structure (304) to support an undo stack that preserves a relationship between a record of each operation and a related part of the data set the operation was applied to; and
display the data structure (304) via a graphical user interface (328) for enabling selection of undo and redo operations (332) associated with only the related part of the data set.

14. The computer-readable medium as recited in claim 13, further comprising instructions, which when executed, cause the computer to:
parse at least some of the data set into the related parts, wherein each part of the data set comprises an object; and
filter the undo stack using an identity of a given object as the filter criterion for creating a sequence of operations eligible to be undone and redone with respect to the given object.

15. The computer-readable medium as recited in claim 14, further comprising instructions, which when executed, cause the computer to:
display the data structure as a visual tree structure comprising a sequence of editing operations arranged according to each object;
arrange undo and redo controls near operations displayed for a given object; and
wherein the undo and redo controls enable selection of undo and redo actions back and forth through the sequence of editing operations for the given object.

16. The computer-readable medium as recited in claim 13, wherein the data structure preserves a relationship between a record of each operation and a part or a subset of an object that the operation was applied to.

17. A computer-readable medium (216), including instructions, which when executed, cause the computer to:
determine (314) a set of features (312) to be modeled by a data set; (306)
record (302) each edit of each feature (312) in a stack; (304)
associate (308) one or more of the features (312) with each recorded edit in the stack; (304)
filter (320) the stack (304) to determine edits associated with a selected feature; and
based on the filtering, undo edits (318) associated with the selected feature in a reverse order while maintaining a current editing state of the other features (312).

18. The computer-readable medium as recited in claim 17, further comprising instructions, which when executed, cause the computer to:
redo undone edits associated with the selected feature in a forward order while maintaining a current editing state of the other features.

19. The computer-readable medium as recited in claim 17, further comprising instructions, which when executed, cause the computer to:
extend a graphical user interface (GUI) to display a linear representation of the chronological stack or to display a tree that shows a filtered stack of edits associated with each feature including edits that apply to a group of objects affected in common by the edit.

20. The computer-readable medium as recited in claim 17, further comprising instructions, which when executed, cause the computer to:
display undo and redo controls on the GUI;
arrange the undo and redo controls on the GUI at depictions of past edits currently eligible to be undone or redone, for each feature of the model.
